(19) United States
(12) Patent Application Publication
(10) Pub. No.: US 2010/0261594 A1
(43) Pub. Date: Oct. 14, 2010

(54) RESILIENT TUCKER ELEMENT FOR INTERFOLDER FOLDING ROLLS

(75) Inventors: James R. Michler, Ashland, WI (US); Austin M. Macholl, Ironwood, MI (US)

Correspondence Address: REINHART BOERNER VAN DEUREN P.C., 2215 PERRYGREEN WAY, ROCKFORD, IL, 61107, US

(73) Assignee: C.G. BRETTING MANUFACTURING CO., INC., Ashland, WI (US)

(21) Appl. No.: 12/420,441

(22) Filed: Apr. 8, 2009

(51) Int. Cl. B31F 1/00; B31F 1/10

(52) U.S. Cl. 493/415; 493/428; 493/425

(57) ABSTRACT

A method and apparatus are provided for facilitating folding of material fed through a nip between two folding rolls having a tucker on one roll and a corresponding gripper on the other roll, by using a resilient tucker element having a tip that is moveable from a neutral position thereof, through elastic deformation of at least a portion of a body of the tucker element, for directing a portion of the material into the gripper. The resilient tucker element may have a tucker body formed at least partially of elastically resilient material fixedly attached at a proximal end thereof to the other roll. A portion of a distal end of the resilient tucker element may be wedge-like and have vacuum ports extending at least partially into the wedge-like portion, for securing an end of a sheet of material being fed through the nip between the folding rolls.

### FIELD OF THE INVENTION

This invention pertains to folding machines and more particularly to a tucker arrangement using a resilient tucker element for directing sheets of material passing through a nip between two rolls of an interfolding machine into a gripper arrangement within the rolls.

### BACKGROUND OF THE INVENTION

For products such as facial tissues or hand towels, it is often desirable to interfold adjacent sheets into a stack of folded sheets in such a manner that, as each sheet is removed from a dispenser, a portion of the next sheet is also pulled from the dispenser and left exposed to facilitate removal of that sheet from the dispenser at a later time. To achieve such an arrangement, individual sheets in the stack are folded into two or more panels to form V, Z, W or other shaped sheets, with one or more panels of adjacent sheets overlapping one another to form the interfolded stack.

Such interfolded stacks are often formed with machinery utilizing a pair of cooperating interfolding rolls that are rotatably disposed with respect to one another to form a nip between the folding rolls. The interfolding rolls are configured to accomplish a desired interfolding pattern as one or more webs or sheets of material are fed through the nip. Specifically, in a typical interfolding arrangement, each of the interfolding rolls may have at least one circumferentially-spaced gripper arrangement therein which is disposed in timed relationship with at least one gripper arrangement of the other interfolding roll. The rolls also typically each include respective tucker arrangements, which are also arranged in a circumferentially-spaced timed relationship to the gripper arrangement of the other roll, in such a manner that the tucker of one roll is substantially aligned with the gripper apparatus of the other roll as the gripper arrangements of each roll respectively pass through the nip.

Typically, the gripper arrangement is recessed below the surface of the roll in which the gripper is mounted, and the tucker protrudes beyond the surface of the roll in which the tucker is mounted. In some gripper arrangements, however, the grippers protrude outside of the roll and the tuckers are recessed below the surface of the roll. Regardless of whether the gripper or the tuckers protrude outside of the roll, the tucker functions to direct one or more overlapped layers of material in to the gripper, and to assist the gripper in forming the fold, as the material passes through the nip between the folding rolls.

The tucker arrangement typically includes a tip which is configured for operative engagement with a corresponding gripper apparatus on the other roll. The tip of the tucker is used for guiding one or more sheets of material passing through the nip with the tucker into the corresponding gripper on the other roll.

For proper operation of an interfolding arrangement having tucker arrangements wherein the tucker protrudes beyond the periphery of the roll in which the tucker is mounted, it is generally necessary that the tip of the tucker extend beyond the periphery of both the roll to which the tucker is attached, and also past the periphery of the other roll, in order for the tip of the tucker to properly interact with the gripper carried by the other roll. In similar fashion, in tucker arrangements wherein the gripper protrudes beyond the periphery of the roll in which the gripper is mounted, it is generally necessary for the outer end of the gripper to extend beyond the periphery of both the roll to which the gripper is attached, and also past the periphery of the other roll, in order for the tip of the gripper to properly interact with the tucker carried by the other roll.

Simply stated, either the tip of the tucker, or the end of its associated gripper typically extends beyond the periphery of the roll in which the tucker or gripper is mounted and inside of the periphery of the other roll. As a result, some degree of contact and potential interference between the tips of the tuckers and their corresponding gripper arrangements is inherent in operation of such an interfolding apparatus. Such contact and interference causes undesirable noise and vibration during the interfolding process, and has necessitated the use of closely-toleranced, complex parts in order to achieve proper operation in prior interfolding apparatuses. The end of a protruding gripper, or the tip of a protruding tucker, are disposed at a greater radial distance from the rotational center of the roll in which the protruding gripper or tucker is mounted. This results in the tangential velocity of the end of the protruding gripper or the tip of a protruding tucker being higher than that of its corresponding mating part, and poses an inherent problem in the design and operation of interfolding equipment.

It has been observed in some prior gripper and tucker arrangements that the gripper may bounce off of, or out of engagement with, its associated tucker, and thus lose control of the material being folded, as a result of some of the above-described inherent design and operational problems.

Some gripper arrangements incorporate a mechanical gripping finger which clamps against an anvil of the gripper arrangement to grasp the sheets of material which have been pressed into the gripper between the end of the arm and the anvil by the tip of the tucker. As the gripper arrangement closes, the tip of the tucker is also clamped by the gripper. The tip of the tucker must somehow disengage from the gripper, preferably as smoothly as possible, as the tucker and its corresponding gripper move away from the nip as the rolls continue to rotate.

In order to facilitate the operation of interfolding apparatuses, some prior interfolding apparatuses have utilized tucker elements having unitary bodies of rigid materials which are attached to the roll by a mechanical arrangement that allows the tip of the tucker element to rotate slightly in a circumferential direction or to be moved radially inward as a result of contact with the gripper arrangement. Although, such prior moveable tuckers have involved considerable mechanical complexity, they have not provided performance that is entirely satisfactory. Examples of such prior approaches to providing moveable tucker arrangements are provided by: U.S. Pat. No. 1,871,301 to Campbell; U.S. Pat. No. 1,595,992 to Cannard; U.S. Pat. No. 2,468,254 to Deloye; U.S. Pat. No. 4,270,744 to Trogan; and U.S. Pat. No. 4,822,328 to Bertolini.

Movable tucker arrangements in such prior interfolding apparatuses have been limited to a small range of motion in substantially only one direction. Smooth operation during interfolding would be facilitated by having a tucker that has a greater range and freedom of movement in a more complex path involving simultaneous movement in more than one direction.

Published US Patent Publication No. 2005/0070417, to White et al., titled “Self-Centering Tucker Assembly for a Folding Roll,” discloses a tucker assembly having a tucker element that is both spring loaded in a radially outward opening slot in a folding roll and pivotably mounted within the slot to allow the tucker to pivot within the slot and retract within the slot against a biasing force of the spring. While this arrangement does allow the tucker element of White to both pivot about a pivot axis and retract in the slot, the arrangement is mechanically overly complex and too cumbersome to be practical.

Generally speaking, and to address one or more of the shortcomings discussed above, further improvement is desirable in interfolding apparatuses and methods for dealing with problems associated with interaction between the tip of the tucker and the gripper apparatus.

### BRIEF SUMMARY OF THE INVENTION

The invention provides an improved method and apparatus for folding sheet material fed through a nip between two folding rolls, by directing a portion of the material into a gripper arrangement on one of the rolls with the tip of a resilient tucker element on the other roll which is capable of considerably greater movement than prior moveable tuckers. By forming a body of the tucker element from an elastically resilient material, such as polyurethane, a distal end of the tucker element is movable from a neutral position thereof as a result of elastic deformation of the elastically resilient material of the body of the tucker element. This arrangement provides significantly improved performance in an apparatus or method incorporating a resilient tucker element according to the invention, and also allows vacuum or air ports to be placed much closer to an apex of a protrusion at the distal end of the tucker element than could be achieved with prior movable tucker elements.

In one form of the invention, a resilient tucker element is provided for a folding roll which is rotatable about a roll axis and defines a substantially circumferential periphery of the roll disposed about the roll axis. The resilient tucker element includes a body of the tucker element defining proximal and distal ends of the tucker element. The body of the tucker element is formed at least partly from an elastically resilient material, and is configured for operative attachment to the folding roll. The distal end of the tucker element is movable from a neutral position thereof, with respect to the proximal end of the tucker element, through elastic deformation of the elastically resilient material of the body of the tucker element.

In some forms of the invention, the distal end of the tucker element is movable with respect to the proximal end of the tucker element through at least one of the group of elastic deformations of the elastically resilient material in the body of the tucker element consisting of: compression; extension; simple-bending; and compound-bending. In other forms of the invention, the distal end of the resilient tucker element is movable simultaneously in at least two of the elastic deformations delineated above, and in yet other forms of the invention, the distal end of the resilient tucker element is movable simultaneously in at least three of the elastic deformations delineated above.

As used herein, it is intended that the term “resilient” have its common dictionary definition as an adjective describing a body which springs back, rebounds, and returns to its original form or position after being bent, compressed, stretched or otherwise deformed. The term “elastic deformation,” as used herein, is intended to communicate that the elastically resilient material in the body of a tucker element, according to the invention, will return to its original form or position substantially without suffering any permanent deformation or degradation.

A resilient tucker element, according to the invention, may have a tucker body formed at least partially of elastically resilient material fixedly attached at a proximal end thereof to one of the folding rolls. A distal end of the resilient tucker element may include a wedge-like protrusion having vacuum ports extending at least partially into the wedge-like protrusion.

In some forms of the invention, the tucker body may further be formed at least partially from an elastically resilient material which also has inherent damping characteristics with regard to damping the elastic deformation of the tucker. As used herein, it is intended that the term “inherent damping characteristic” have its common dictionary definition as an noun describing the ability of a material to decrease the amplitude of a motion, vibration, or an oscillation of the tucker body through absorption or dissipation of energy stored in the tucker body, as a result of the elastic deformation of the tucker body. In some forms of the invention, the body of the tucker element is formed at least partially from a material such as polyurethane which is known to have an inherent damping characteristic in addition to being elastically resilient.

In one form of the invention, a resilient tucker element is provided for a folding roll which is rotatable about a roll axis and defines a substantially circumferential periphery of the roll disposed about the roll axis. The resilient tucker element includes a body of the tucker which is configured to be operatively attachable to the folding roll. The resilient tucker element also includes a tip of the tucker which extends outward beyond the periphery of the folding roll when the tip is in a neutral position thereof. The tip is moveable from the neutral position thereof simultaneously in at least two of the three directions consisting of: substantially radially inward toward an axis of the roll; substantially circumferentially along a periphery of the folding roll; and, substantially in a compound-bending motion about a compound-bending axis of the tip.

The tucker tip, in a resilient tucker element according to the invention, may extend a first distance from the periphery of the folding roll when the tucker tip is in the neutral position, and be moveable to a second distance from the periphery of the roll which is less than the first distance from the folding roll. In some forms of the invention, the tip of the tucker may be moveable to a non-protruding position whereat the tip does not extend beyond the periphery of one or both of the folding rolls.

In some forms of the invention, a resilient tucker element may be at least partly formed from an elastically resilient material, such as polyurethane, or another suitable material. The tucker tip may be at least partly formed from a hard, wear resistant and low friction material. In some forms of the invention, the tucker tip may be at least partly formed from a metallic material. In various forms of the invention, the tucker tip may be at least partly formed from a material of the group consisting of: metallic materials such as steel, ceramic, and high durometer urethane or other plastic.

In some forms of the invention, a resilient tucker element is provided for an interfolding apparatus having a pair of cooperating interfolding rolls which are rotatably disposed to form a nip therebetween. Each roll has at least one circumferentially spaced gripper arrangement therein, disposed in timed relationship to the at least one gripper arrangement of the other of the interfolding rolls. The rolls also each define respective tucker mounting surfaces which are circumferentially spaced in a timed relationship to the gripper arrangement of the other roll such that the tucker mounting surface of one roll is substantially aligned with the gripper apparatus of the other roll as the gripper arrangements of the each roll respectively pass through the nip.

A resilient tucker element, according to the invention, may be formed at least partly from elastically resilient material attached at a proximal end thereof to the tucker mounting surface of one of the rolls, and having a distal end thereof configured for operative engagement with the gripper apparatus on the other roll, for guiding one or more sheets of material passing through the nip substantially simultaneously with the distal end of the tucker on the one roll into the gripper on the other roll.

The proximal end of the tucker body, of a resilient tucker element according to the invention, may be fixedly attached to the roll. The tucker body may include a base at the proximal end thereof, configured for fixed attachment of the resilient tucker element to the mounting surface of the roll.

Where a tucker body, according to the invention, includes a tucker tip at the distal end thereof, a tucker base at the proximal end thereof, and an intermediate section of the tucker extending between the tip and the base, at least the intermediate section of the tucker may be formed at least partly from an elastically resilient material.

A resilient tucker element, according to the invention, may also include one or more passages extending in fluid communication through the base, the intermediate section and the tip, and terminating in ports at the tip of the resilient tucker element. The passages may be tapered from a larger cross-sectional area adjacent the base to a smaller cross-sectional area adjacent the ports.

In some forms of the invention, the tip of the resilient tucker element includes a wedge-like protrusion defining a leading face side and a trailing face side of the wedge-like protrusion. The leading and trailing face sides are disposed on opposite faces of the wedge-like protrusion, with the ports being disposed on one side or the other of the wedge-like protrusion. In some forms of the invention, at least one port may be disposed on the leading face side of the resilient tucker element and at least one port may be disposed on the trailing face side of the resilient tucker element. In some forms of the invention, at least one port disposed on the trailing face side of the resilient tucker element may extend substantially radially outward through at least a portion of the trailing side of the wedge-like protrusion. By virtue of this arrangement, the leading edge of a sheet of material passing through the nip may be gripped through the application of vacuum at a point along the trailing face substantially closer to the apex of the wedge-like protrusion than is achievable in prior movable tucker elements. In various forms of the invention, a port may, or may not, extend through the wedge-like protrusion.

As used herein, the term “wedge-like” is intended to describe primarily a functional characteristic of the protrusion from the tip of a tucker element according to the invention. In some forms of the invention, the wedge-like protrusion may have a substantially wedge-shaped profile, with substantially flat leading face and trailing face sides oriented at an angle to one another, so as to intersect substantially at an apex of the wedge-like protrusion. In other forms of the invention, however, the protrusion may take other appropriate shapes in keeping with the invention. For example, it is contemplated that in some embodiments of the invention either or both of the faces of the wedge-like protrusion may be convex, concave, or not angled.

The invention may also take the form of a folding apparatus including a pair of cooperating interfolding rolls, and one or more resilient tucker elements according to the invention. The pair of cooperating interfolding rolls may be rotatably disposed to form a nip therebetween, with each roll having at least one circumferentially spaced gripper arrangement therein disposed in timed relationship to at least one gripper arrangement carried by the other interfolding roll. The rolls may also each define respective tucker mounting surfaces circumferentially spaced in a timed relationship to the gripper arrangement of the other roll, such that the tucker mounting surface of one roll is substantially aligned with the gripper apparatus of the other roll as the gripper arrangements of each roll respectively pass through the nip. The resilient tucker element may have a tucker body formed at least partly of elastically resilient material which is attached at a proximal end thereof to the tucker mounting surface of one of the rolls. The resilient tucker element may also have a distal end thereof configured for operative engagement with the gripper arrangement on the other roll, for guiding one or more sheets of material passing through the nip substantially simultaneously with the distal end of the tucker on the one roll into the gripper on the other roll.

Each of the rolls, in a folding apparatus according to the invention, may define an outer substantially circumferential surface thereof and rotate about its own respective axis of rotation. Each roll may further include a longitudinally extending channel therein having sidewalls and a bottom surface of the channel disposed radially inward toward the axis from the outer surface of the roll, with a bottom surface of the channel forming the mounting surface for the proximal end of the body of the resilient tucker element. The proximal end of the resilient tucker element may include a base fixedly attached to the mounting surface. In some forms of the invention, the base of the tucker element may be attached to the mounting surface by one or more fasteners. In some forms of the invention, these fasteners may be threaded fasteners. In other forms of the invention, other types of fasteners, such as rivets, clips, clamps, dovetail arrangements, or any other appropriate fastening arrangement may be utilized. In yet other forms of the invention, the bases of the tucker element may be bonded to the mounting surface of the roll with mounting arrangements utilizing adhesives, or other appropriate bonding approaches.

In some forms of the invention, a resilient tucker element may include a tucker body which is attachable at a proximal end thereof to the tucker mounting surface of one of the rolls, and further having a tucker tip at a distal end thereof configured for operative engagement with the gripper apparatus on the other roll. The resilient tucker element may further define one or more passages extending in fluid communication through the tucker body and terminating at at least one port at the tip of the resilient tucker element. The tip may include a wedge-like protrusion extending therefrom and defining a leading face side and a trailing face side of the resilient tucker element disposed on opposite sides of the wedge-like protrusion. The tip may further define at least one port disposed on the trailing face side of the resilient tucker element and extending through at least a portion of the wedge-like protrusion.

The invention may also take the form of a method for folding material fed through a nip fed between two folding rolls, where the method includes directing a portion of the material into a gripper arrangement on one of the rolls with the distal end of a resilient tucker element on the other roll, wherein the resilient tucker element has a tucker body formed at least partly of elastically resilient material fixedly attached at a proximal end thereof to the other roll.

The invention may also take the form of a method for folding material fed through a nip between two folding rolls using a resilient tucker element having a tip which extends past the periphery of one or both of the folding rolls when the tip is in a neutral position thereof, and is moveable from the neutral position simultaneously in at least two of the three directions consisting of: substantially radially inward toward the roll; substantially circumferentially along a periphery of the folding roll; and substantially compound-bending motion about a compound-bending axis of the tip.

Other aspects, objects and advantages of the invention will be apparent from the following detailed description and accompanying drawings of exemplary embodiments of the invention.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a cross-sectional schematic illustration of an exemplary embodiment of a folding apparatus including resilient tucker elements according to the invention.

FIG. 2 is a perspective illustration of an exemplary embodiment of a resilient tucker element, according to the invention.

FIG. 3 is a perspective, partially cut-away, view of the exemplary embodiment of the resilient tucker element according to the invention shown in FIG. 2.

FIG. 4a is an enlarged, partially cut-away schematic illustration of the interaction of a tip of a resilient tucker element according to the invention with a gripper, showing the tucker element in a neutral position thereof with respect to the gripper, in such a manner that the tucker element is not elastically deformed.

FIG. 4b shows the tucker element and gripper of FIG. 4a in a non-aligned arrangement wherein a body of the tucker element is elastically deformed in compression.

FIG. 5a shows the tucker element and gripper of FIG. 4a misaligned in such a manner that the body of the tucker element is elastically deformed in a simple-bending mode in a first direction from the neutral position shown in FIG. 4a.

FIG. 5b shows the tucker element and gripper of FIG. 4a misaligned in such a manner that the body of the tucker element is elastically deformed in a simple-bending mode in a second direction from the neutral position shown in FIG. 4a.

FIG. 6a shows the tucker element and gripper of FIG. 4a misaligned in such a manner that the body of the tucker element is elastically deformed in a compound-bending mode in a first direction from the neutral position shown in FIG. 4a.

FIG. 6b shows the tucker element and gripper of FIG. 4a misaligned in such a manner that the body of the tucker element is elastically deformed in a compound-bending mode in a second direction from the neutral position shown in FIG. 4a.

FIGS. 7 and 7a-7c are partial cross-sectional views, taken along plane 7-7 as shown in FIG. 2, illustrating various alternate embodiments of tucker elements, according to the invention, showing various arrangements of radially outward extending ports and wedge-like protrusions of the tips of the tucker elements.

FIGS. 8-11 are sequential views illustrating movement of a pair of sheets of material through the exemplary embodiment of the folding apparatus of FIG. 1, in an interfolding operation wherein the sheets of material are fed from two directions with one sheet being fed along the periphery of a first folding roll and a second sheet being fed along the periphery of the second folding roll.

FIGS. 12-15 are sequential views of an exemplary embodiment of the invention wherein sheets are fed along the periphery of only one of the interfolding rolls, in accordance with the invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

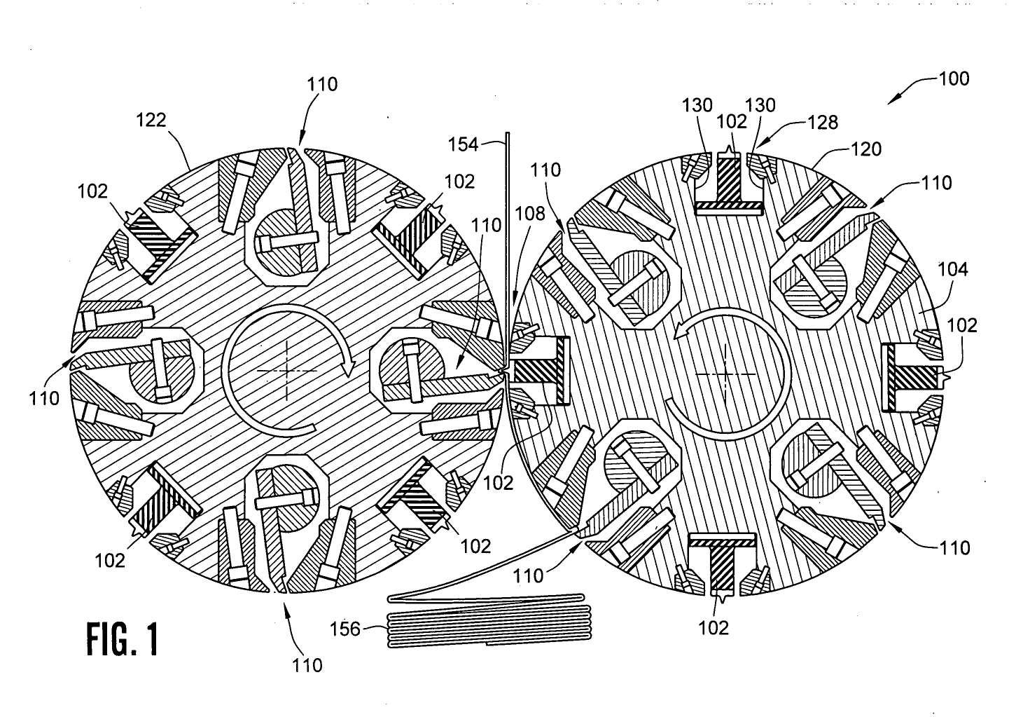

FIG. 1 shows an exemplary embodiment of a folding apparatus 100, according to the invention, which includes a plurality of resilient tucker elements 102 according to the invention. The interfolding rolls 104, 106 rotate at the same speed in opposite directions to one another, as indicated in FIG. 1.

The exemplary embodiment of the folding apparatus 100 includes a pair of cooperating interfolding rolls, in the form of a first interfolding roll 104 and a second interfolding roll 106 which are rotatably disposed with respect to one another to form a nip 108 between the rolls 104, 106, in the manner shown in FIG. 1.

Each of the interfolding rolls 104, 106 includes a plurality of circumferentially-spaced gripper arrangements 110. The gripper arrangements 110 are disposed in each roll 104, 106 in a timed relationship to the gripper arrangement of the other roll 104, 106, in such a manner that the gripper arrangements 110 on the first interfolding roll 104 pass through the nip alternately with the gripper arrangements 110 on the second interfolding roll 106. Specifically, each of the interfolding rolls 104, 106 in the exemplary embodiment of the folding apparatus 100 includes four gripper arrangements 110 circumferentially disposed at 90 degree intervals from one another. Rotational movement of the first and second interfolding rolls 104, 106 is cooperatively timed such that the position of the gripper arrangements 110 on the first interfolding roll 104 are rotationally displaced 45 degrees from the gripper arrangements 110 on the second interfolding roll 106.

Each of the first and second interfolding rolls 104, 106 in the exemplary embodiment of the folding apparatus 100 also includes four of the resilient tucker elements 102 circumferentially spaced 90 degrees from one another and located midway between a respectively-adjacent pair of the gripping arrangements 110. By virtue of the resilient tucker elements 102 being thus positioned within each of the interfolding rolls 104, 106, and the synchronized timing of the relative rotation of the first and second interfolding rolls 104, 106, as each of the gripper arrangements 110 of the second interfolding roll 106 passes through the nip 108, it will come into cooperative engagement with a corresponding one of the resilient tucker elements 102 of the first interfolding roll 104. In similar fashion, as each of the gripper arrangements 110 of the first interfolding roll 104 passes through the nip 108, it will come into cooperative engagement with one of the resilient tucker elements 102 on the second interfolding roll 106.

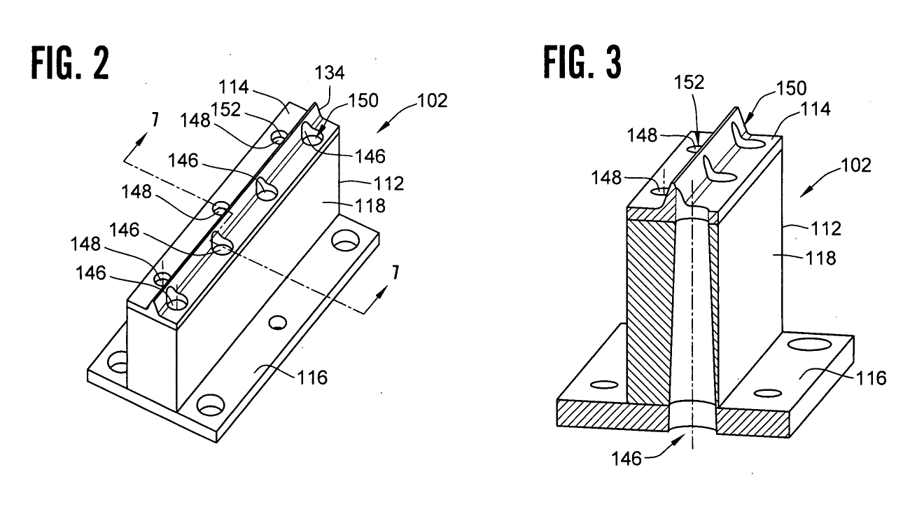

FIGS. 2 and 3 illustrate one of the resilient tucker elements 102 of the exemplary embodiment of the folding apparatus 100. Each of the exemplary embodiments of the resilient tucker elements 102 includes a tucker body 112 having a tucker tip 114 at a distal end of the tucker body 112, a tucker base 116 at a proximal end of the tucker body, and an intermediate section 118 of the tucker extending between the tip 114 and the base 116 of the tucker 102.

In the exemplary embodiment of the resilient tucker element 102, the tip and base 114, 116 of the tucker 102 are formed from a metallic material, such as steel, and the intermediate section 118 of the tucker is formed from an elastically-resilient material such as polyurethane. One suitable polyurethane material is a thermoset castable elastomer having a product designation PCO-05-401-50A, which is available from Prepolymer Products Inc. (also known as, PCO Urethane) of Marshfield, Wis., US. Those having skill in the art will also recognize that such elastically-resilient materials also typically exhibit inherent damping characteristics which provide a substantial advantage in practicing the invention by providing performance that is significantly quieter, and less prone to vibration than any known prior approach. Those skilled in the art will further recognize that prior approaches provided little, if any, damping capability in their movable tucker arrangements.

In general, it is contemplated that the tucker tip will preferably be formed at least partially from a hard, wear resistant and low friction material, such as steel or other metallic materials, ceramic materials, high durometer urethane or another suitable plastic material. For example, it is contemplated that suitable material for the tip of a tucker element, according to the invention, may include materials such as Nylatron, or an Ultra High Molecular Weight Polyethylene. It is further contemplated that the tip may be plated or otherwise coated with a hard, wear resistant and low friction material.

As shown in FIG. 1, each of the first and second interfolding rolls 104, 106 defines a respective outer substantially circumferential surface 120, 122 thereof and rotates about its own respective axis of rotation 124, 126. As stated above, the first and second folding rolls 104, 106 rotate in opposite directions about their respective axis 124, 126 at the same speed as one another in the exemplary embodiment of the folding apparatus 100.

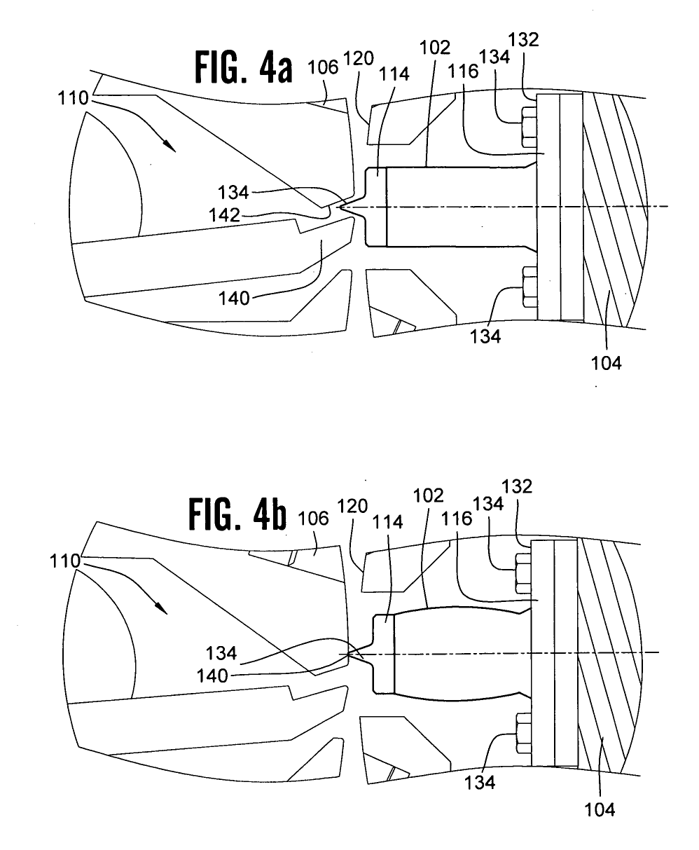

To accommodate the resilient tucker elements 102, each of the interfolding rolls 104, 106 includes four longitudinally-extending channels 128 therein, with each of the channels 128 including sidewalls 130 joined by a bottom surface 132. The bottom surfaces 132 of the channels 128 are disposed radially inward toward the respective axis 124, 128 of the first and second interfolding rolls 104, 106. The bottom surfaces 132 of the channels 128 are also configured as mounting surfaces for fixed attachment thereto of the bases 116 of the resilient tucker elements 102. As shown in FIGS. 4-6, the resilient tucker elements 102 in the exemplary embodiment of the folding apparatus 100 are each attached to the bottom surface 132 of one of the tucker mounting channels 128 by threaded fasteners 134 passing through holes in the base 116 of the resilient tucker element 102. In other embodiments of the invention, the bases 116 of the tucker elements may be attached to the bottom surfaces 132 of the tucker mounting channels 128 by other appropriate means, as elsewhere described herein.

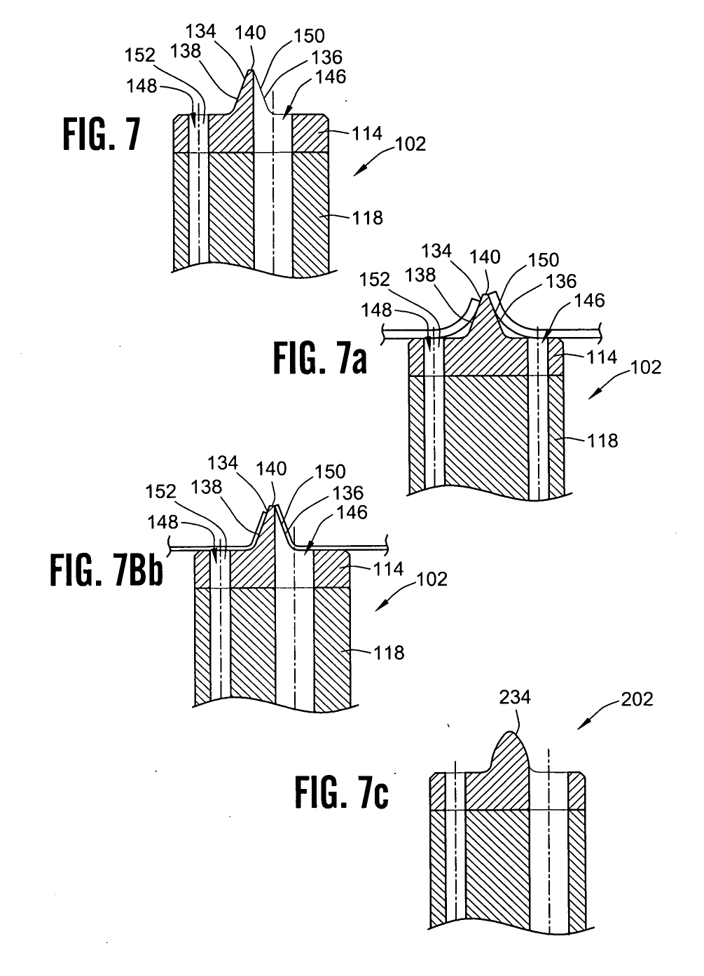

As shown in FIG. 7, the tip 114 of a first exemplary embodiment of the resilient tucker element 102 has a wedge-like protrusion 134 extending outward and longitudinally along the length of the tucker tip 114. The wedge-like protrusion 134 includes a trailing face 136 and a leading face 138, with the leading and trailing faces 136, 138 substantially intersecting one another at an apex 140 to form the wedge-like protrusion 134. In the exemplary embodiment of the resilient tucker element 102, the apex 140 of the wedge-like protrusion 134 is rounded, rather than forming a sharp corner. In other embodiments of the invention, the apex 140 of the wedge-like protrusion 134 may have configurations other than being rounded.

It will be further understood, by those having skill in the art that the terminology “trailing face 136” and “leading face 138” as used herein refer to the orientation of the faces 136, 138 when attached to the interfolding rolls 104, 106 with the rolls rotating in the directions shown in FIG. 1. This nomenclature is selected to illustrate the fact that the leading face 138 approaches the nip 108 between the rolls 104, 106 prior to the trailing face 136. It will be further recognized that where successive sheets being fed through the nip 108 abut one another substantially at the apex 140 of one of the resilient tucker elements 102, the trailing edge of the first sheet will be disposed adjacent the leading face 138 of the wedge-like protrusion 134, and the leading edge of the following sheet will be disposed adjacent the trailing face 136 of the wedge-like protrusion 134.

As shown in FIG. 4a, when the resilient tucker element 102 of the exemplary embodiments is in a neutral position thereof, the wedge-like protrusion 134 of the tucker tip 114 extends outward beyond the substantially circumferential outer periphery 120 of the first interfolding roll 104, across the outer periphery 122 of the second interfolding roll 106, and into a gap formed between a moveable finger 140 and an anvil portion 142 of a corresponding gripper arrangement 110 of the second interfolding roll 106.

As shown in FIG. 4b, the above-described construction of the tucker 102 allows the tip 114 of the tucker 102 to move substantially radially inward, by virtue of compression of the intermediate section 118, from the neutral position shown in FIG. 4a, to a second, compressed, position shown in FIG. 4b, whereat the apex 140 of the wedge-like protrusion 134 of the tucker tip 114 is disposed at a second distance from the periphery of the roll 104 which is less than a first distance of the apex 140 from the periphery of the roll 104.

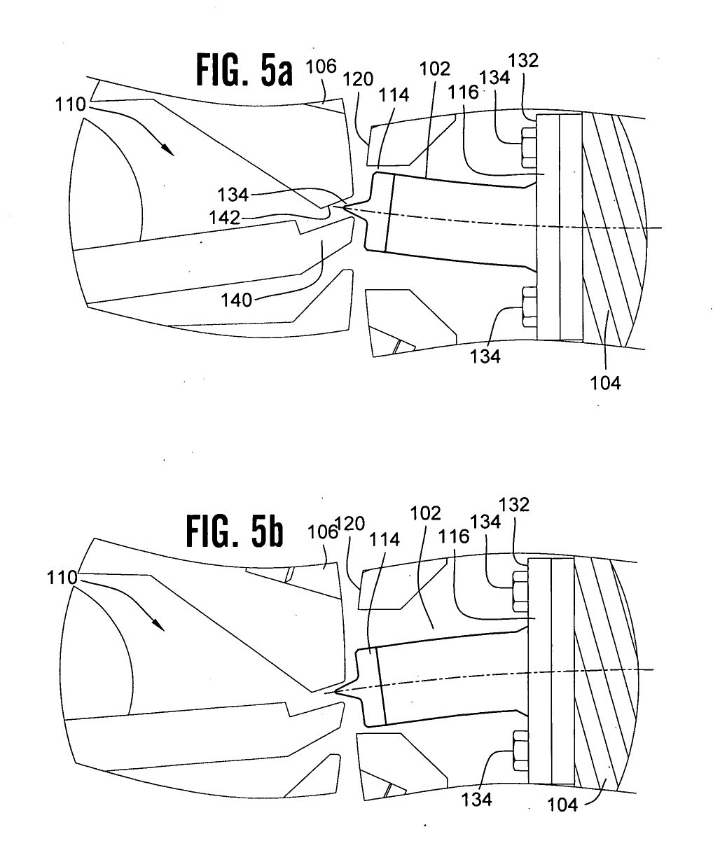

As further illustrated in FIGS. 5a and 5b, by virtue of the above-described construction of the resilient tucker element 102, and particularly as a result of forming the intermediate section 118 of the resilient tucker element 102 from an elastically-resilient material such as polyurethane, the tip 114 of the tucker 102 is moveable in a substantially circumferential direction along the periphery 120 of the folding roll 104 in either direction from the neutral position (as shown in FIG. 4a) of the tip 114 of the tucker 102, through simple-bending of the intermediate section 118 of the tucker element 102. As used herein, the term “simple-bending” refers to a bending mode as illustrated in FIGS. 5a and 5b wherein the tucker body 112 elastically deforms along a substantially arcuate line extending from the base 116 of the tucker 102 through the tip 114 of the wedge-like protrusion 134 of the tip 114, in either a first direction as indicated in FIG. 5a or a second direction as indicated in FIG. 5b.

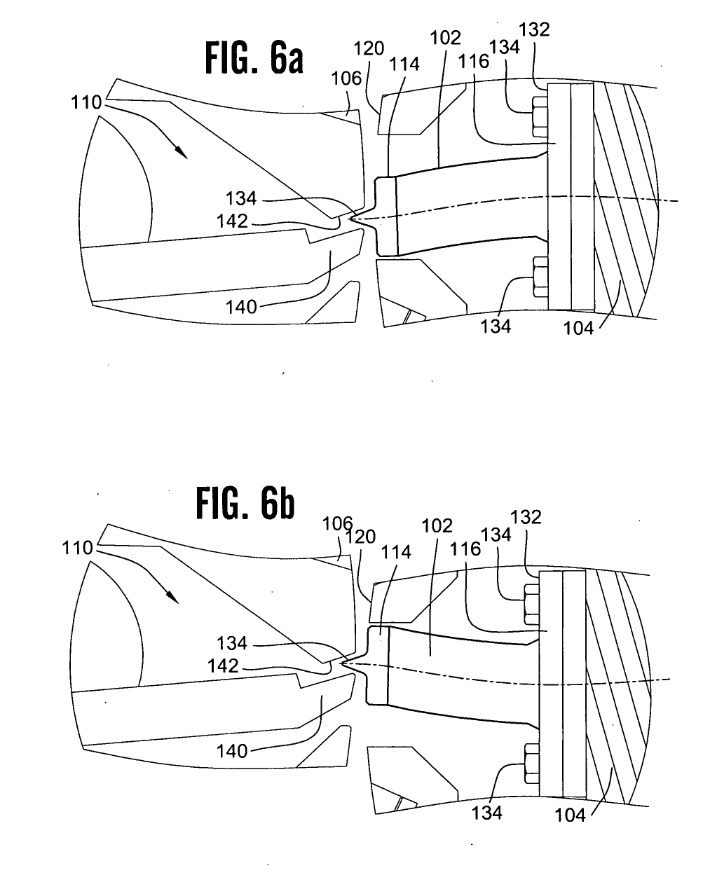

As shown in FIGS. 6a and 6b, in addition to allowing movement through simple-bending in a substantially circumferential direction, as shown in FIGS. 5a and 5b, and movement of the tip 114 in a substantially radial direction, as shown in FIGS. 4a and 4b, the above-described construction allows the tip 114 of the exemplary embodiment of the resilient tucker element 102 to also move in a compound-bending fashion in the manner illustrated in FIGS. 6a and 6b. As used herein, the term “compound bending” is intended to encompass any mode of bending or movement of the tucker element 102 in such a manner that the wedge-like protrusion 134 of the tip 114 of the tucker 102 does not follow a single substantially arcuate line of bending extending from the base 116 through the apex 152 of the wedge-like protrusion 134, as illustrated in FIGS. 5a and 5b. In the compound-bending modes illustrated in FIGS. 6a and 6b, the bending line extending from the tucker base 116 through the apex 140 of the wedge-like protrusion 134 forms a substantially S-shaped curve, allowed by having the tucker body 112 formed from the elastically resilient material. It will be understood that the construction of the resilient tucker 102 allows a virtually unlimited number of other compound-bending movements in addition to the S-shaped curves specifically illustrated in FIGS. 6a and 6b.

As will be further understood by those having skill in the art, by virtue of the above-described construction, the exemplary embodiment of the resilient tucker element 102 is also capable of simultaneous movement in at least two, and in some applications even three or more directions or modes (i.e. circumferentially, radially, simple-bending and compound-bending). The above-described construction also results in the tip 114 of the tucker 102 being moveable to a non-protruding position, as illustrated in FIG. 4b, for example, whereat the apex 140 of the wedge-like protrusion 134 does not extend beyond the periphery 120 of the roll 104.

Those having skill in the art will recognize that the ability for the tucker tip 114 to simultaneously move in two or more directions provides substantial advantage over prior art tuckers and folding apparatuses and methods utilizing interacting gripper and tucker arrangements. It will be further recognized that the additional functionality of a resilient tucker element, in accordance with the invention, is achieved without resorting to the mechanical complexity of prior movable tucker arrangements, and in fact is accomplished in a manner which is elegantly much simpler than previous approaches.

As illustrated in FIGS. 2, 3 and 7, the exemplary embodiment of the resilient tucker element 102 may also include one or more passages 146, 148 extending in fluid communication through the tip 114, the intermediate section 118 and the base 116 of the tucker 102, and terminating in ports 150, 152 disposed respectively adjacent to the trailing face 136 and the leading face 138 of the wedge-like protrusion 134 at the tip 114 of the resilient tucker element 102.

As further shown in FIGS. 2, 3 and 7, the ports 150 on the trailing face 136 side of the tip 114 of the exemplary embodiment of the resilient tucker element 102 may extend radially outward through a portion of the trailing face 136 of the wedge-like protrusion 134. It will further be recognized, that in other embodiments of the invention the ports 152 on the leading face 138 side of the tip 114 may also extend radially outward through the leading face 138 of the wedge-like protrusion 134.

Those having skill in the art will recognize that the passages 146, 148 and the ports 150, 152 may be utilized for selectively applying either vacuum or air pressure closely adjacent to the wedge-like protrusion 134 to facilitate holding sheets of material in place with vacuum along or across the wedge-like protrusion 134 during operation of the folding apparatus 100, or alternately for causing the sheet to move away from the tip 114 by application of air pressure through the passages 146, 148 during portions of folding operations in some embodiments of the invention.

Those having skill in the art will further recognize that the above-described design features of the present invention allow the ports 150, 152 to be placed closer to the wedge-like protrusion 134 than has typically been achievable in prior tucker arrangements. It will particularly be recognized by those skilled in the art that the ability to have the ports 150 on the trailing face 136 side of the wedge-like protrusion 134 extend radially outward through a portion of the trailing face 136 of the wedge-like protrusion 134 provides substantial advantage in holding the leading edge of a sheet being interfolded in a desired position on the trailing face 136 of the wedge-like protrusion 134 of the tip 114 of the resilient tucker element 102.

As shown in FIG. 3, in some embodiments of the invention, it may be desirable to taper passages 146, 148 extending through the resilient tucker element 102, in the manner illustrated for the passage 146, from a larger cross-sectional area adjacent the base 116 to a smaller cross-sectional area adjacent the ports 150. Such tapering has been shown to be advantageous in keeping the passages 146, 148 free of debris during operation of the folding apparatus.

As illustrated in FIG. 7b, the arrangement of the ports 150 and 152 described above in conjunction with FIG. 7 work well for folding of thin materials, such as facial tissue. As is known in the art, where the material being folded is very thin it is more difficult to securely hold a leading edge of the sheet being folded against the trailing face 136 of the wedge-like protrusion 134 than it is to hold the trailing end of the preceding sheet against the leading face side 138 of the wedge-like protrusion 134. In such applications, the invention provides a major improvement over prior tucker elements by allowing the port 150 to extend radially outward through a portion of the trailing edge side 136 of the wedge-like protrusion 134. As further illustrated in the embodiment shown in FIG. 7b, the port 152 located in the tip 114 ahead of the wedge-like protrusion 134 may not need to extend through the leading face side 138 of the wedge-like protrusion 134 in some embodiments of the invention.

As shown in FIG. 7a, where the material being folded is thicker, as is the case in interfolding hand towels for example, the additional stiffness of the thicker material makes it more difficult to pull the leading and trailing ends of successive sheets into intimate contact with the entirety of the leading edge side 138 and the trailing edge side 136 of the wedge-like protrusion 134. In such applications, it may be desirable, therefore, to have both the ports 150, 152 spaced respectively downstream and upstream from the faces 136 and 138 of the wedge-like protrusion 134.

It will be further understood that the use of the term “wedge-like” herein is intended to refer primarily to the function of the protrusion 134 in “wedging” the material being folded into the gripper. Accordingly, it is contemplated that the wedge-like protrusion may have a variety of shapes other than those specifically illustrated and discussed above with regard to FIGS. 7, 7a and 7b wherein the wedge-like protrusion 134 is substantially also wedge-shaped. In practicing the invention, the wedge-like protrusion may take any other appropriate form, such as the alternate embodiment of the wedge-like protrusion 234 in the embodiment of the resilient tucker element 202 illustrated in FIG. 7c.

It will also be appreciated, by those having skill in the art, that the above-described construction lends itself well to forming the resilient tucker elements 102 by a molding process, wherein a polyurethane material is fed into a space in a mold containing the tip 114, the base 116 and a series of rods (which may, or may not, be tapered) defining the passages 146, 148. The ability to mold the resilient tucker elements 102 in essentially a final shape, provides substantial advantage over prior approaches utilizing movable tucker elements which had to be manufactured in many steps using multiple complex parts and equipment. It will also be recognized, that in some embodiments of the invention utilizing materials such as polyurethane for both the tip 114 and the base 116 of the resilient tucker element 102, in addition to the intermediate section 118 of the tucker 102, that the entire resilient tucker element 102 may simply be molded by injecting the polyurethane material into a cavity in the mold. In some embodiments, a hard plating or other type of coating may then be applied over the distal end of the resilient tucker element 102, to provide wear resistance and reduced friction.

FIG. 1 illustrates a folding operation, using the exemplary embodiment of the invention, to form a single web 154 of material into a folded stack 156 of material. In some embodiments of the invention, the folding apparatus or method may also include provisions (not shown) for perforating or scoring the web of material 154 at periodic intervals (perhaps corresponding to some of the folds), such that individual sheets may be readily torn from the stack 156 of folded material.

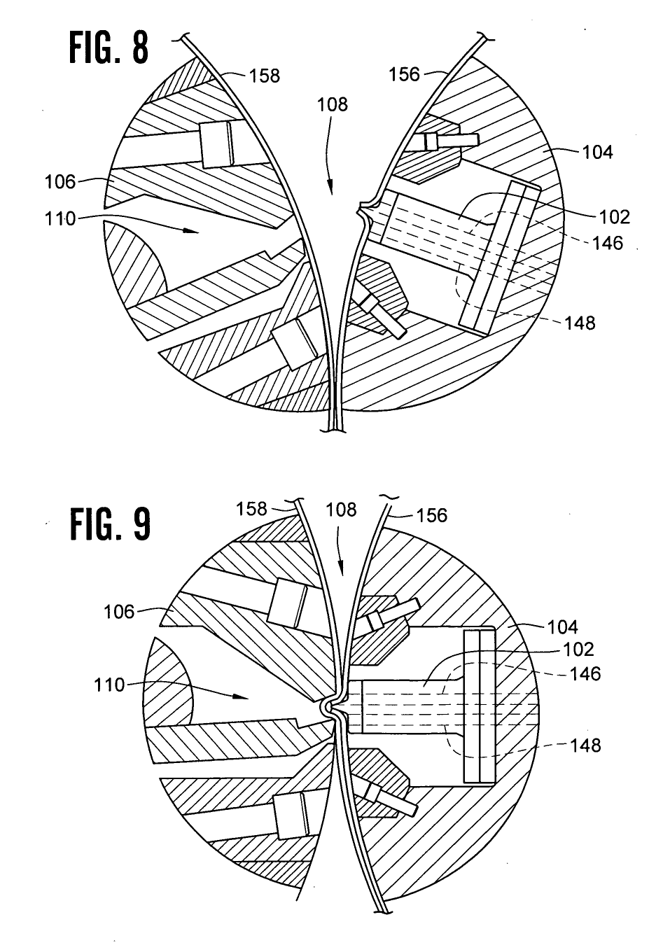

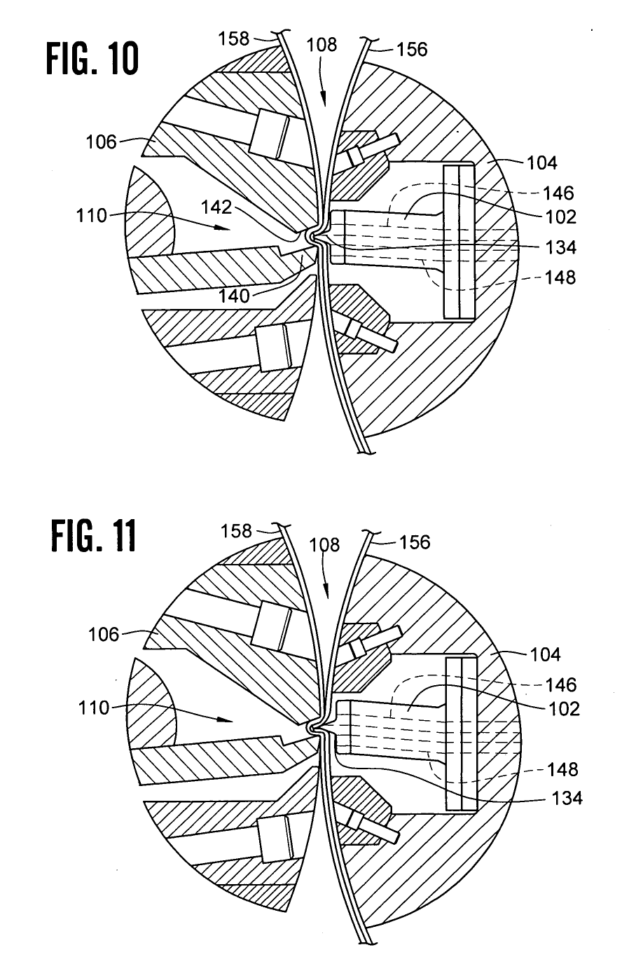

FIGS. 8-11 show sequential views of a folding operation, utilizing the exemplary embodiment of the folding apparatus 100 described above to interfold a first and a second sheet 156, 158 of material, through cooperative operation of the resilient tucker element 102 with the gripper arrangement 110, as the leading edge of the first sheet 156 moves through the nip 108 and is interfolded into a fold in the second sheet 158. As illustrated particularly in FIGS. 10 and 11, as the moveable finger 140 begins to close against the anvil portion 142 of the gripper arrangement 110, by virtue of actuation arrangement disposed within the roll (as is known in the art), so that the gripper arrangement 110 can grasp the first and second sheets 156, 158 to form the fold, closure of the finger 140 against the anvil 142 exerts a pressure on the angled faces 136, 138 of the wedge-like protrusion 134. This pressure on the angled faces 136, 138 of the wedge-like protrusion 134 results in the wedge-like protrusion 134 being effectively “squeezed out” and moved away from the nip 108 through a combination of one or more of the above-described circumferentially directed, radially directed, simple-bending, or compound-bending movements of the end of the resilient tucker element 102.

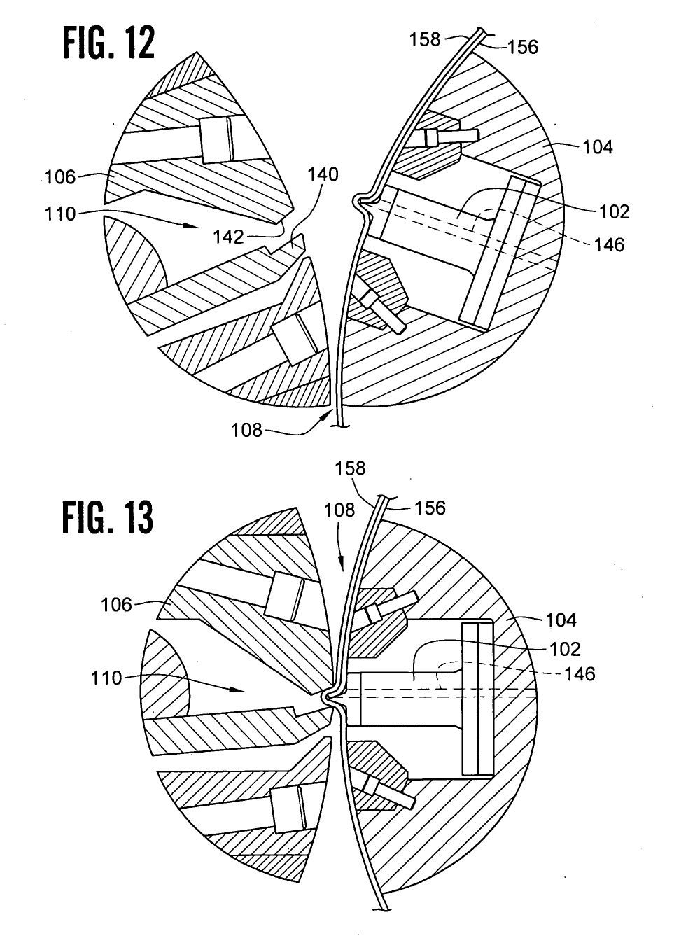

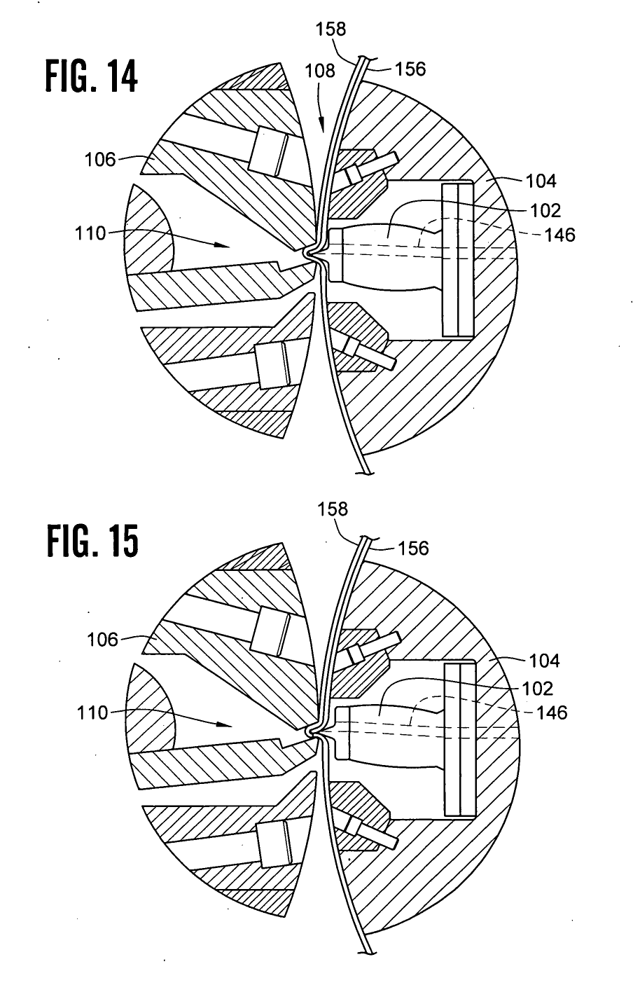

FIGS. 12-15 are sequential views of an alternate embodiment of the invention, in which the exemplary embodiment of the folding apparatus 100 is utilized for interfolding the first and second sheets 156, 158 in an arrangement or process wherein both the first and second sheets 156, 158 are fed along the surface of only one of the interfolding rolls 104, 106 (specifically, in this case along the first interfolding roll 104) rather than having alternating sheets fed along the surfaces of both the first and second interfolding rolls 104, 106 as described above in relation to FIGS. 8-11. It will be understood that, in other embodiments of the invention, the first and second sheets 156, 158 may be fed along the surface of only the second interfolding roll 106.

From the foregoing descriptions of exemplary embodiments of apparatuses and methods according to the invention, those skilled in the art will readily recognize that the present invention provides substantial advancements with regard to the construction and operation of resilient tucker elements, and apparatuses and methods which can benefit from the use of such resilient tucker elements.

It is contemplated that various aspects of the invention may be utilized in a wide variety of folding equipment differing substantially in construction and operation from the exemplary embodiments described in detail herein. For example, as illustrated in FIG. 1, the invention may be practiced with efficacy in folding methods and apparatuses where only a single sheet is present at the nip between the folding rolls, or in methods and apparatuses having the web or sheets of material being acted upon entering and/or leaving the nip in the folding rolls in a manner substantially different than that shown in the exemplary embodiments described herein. Those having skill in the art will recognize that the arrangement illustrated in FIG. 1 is sometimes utilized in so-called “bandsaw-style” napkin folders, or in embodiments of interfolders where the sheets are guided straight down between a pair of guides. In bandsaw-style folders, the folded web produced downstream of the folding rolls 104, 106 is sawed lengthwise (into the page as shown in FIG. 1) to form two identical but oppositely folded stacks of material.

It is also contemplated that the invention may be used with efficacy in folding arrangements where the tips of the resilient tucker elements do not protrude beyond the periphery of the folding roll in which they are mounted. It is further contemplated that resilient tucker elements, according to the invention, may be operatively attached to the folding roll in some manner other than the fixed attachments described herein. For example, it is contemplated that in other embodiments of the invention it may be desirable to attach a resilient tucker element according to the invention to a folding roll using some sort of moveable connection whereby the resilient tucker element may translate, pivot or otherwise move with respect to the folding roll in combination with movement of the tip of the tucker being provided through the elastic deformation of the resilient tucker element.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A resilient tucker element, for a folding roll which is rotatable about a roll axis and defines a substantially circumferential periphery of the roll disposed about the roll axis, the resilient tucker element comprising:
a body of the tucker element, at least partly formed from an elastically resilient material, defining distal and proximal ends of the tucker element, and configured for operative attachment to the folding roll;
the distal end of the tucker element being movable from a neutral position thereof with respect to the proximal end of the tucker element through elastic deformation of the elastically resilient material of the body of the tucker element.

2. The resilient tucker element of claim 1, wherein, the distal end of the tucker element is movable with respect to the proximal end of the tucker element through at least one of the group of elastic deformations of the elastically resilient material in the body of the tucker element consisting of: compression; extension; simple-bending; and, compound-bending.

3. The resilient tucker element of claim 1, wherein, the distal end of the tucker element is simultaneously movable with respect to the proximal end of the tucker element through at least two of the group of elastic deformations of the elastically resilient material in the body of the tucker element consisting of: compression; extension; simple-bending; and, compound-bending.

4. The resilient tucker element of claim 1, wherein, the distal end of the tucker element is simultaneously movable with respect to the proximal end of the tucker element through at least three of the group of elastic deformations of the elastically resilient material in the body of the tucker element consisting of: compression; extension; simple-bending; and, compound-bending.

5. The resilient tucker element of claim 1, wherein, the tucker element body is formed at least partially from a polyurethane material.

6. The resilient tucker element of claim 1, wherein, the tucker element body is formed at least partially from a material having inherent damping characteristics, for counteracting the elastic deformation of the body of the tucker element.

7. The resilient tucker element of claim 6, wherein, the tucker element body is formed at least partially from a polyurethane material.

8. The resilient tucker element of claim 1, further comprising, one or more passages extending in fluid communication through the base and the intermediate section and the tip, and terminating in ports at the tip of the resilient tucker element.

9. The resilient tucker element of claim 8, wherein, the passages are tapered from a larger cross sectional area adjacent the base to a smaller cross sectional area adjacent the ports.

10. The resilient tucker element of claim 8, wherein, the tip includes a wedge-like protrusion extending therefrom defining a leading face side and a trailing face side of the resilient tucker element disposed on opposite sides of the wedge-like protrusion, with the ports being disposed on at least one side of the wedge-like protrusion.

11. The resilient tucker element of claim 10, further comprising, at least one port disposed on the leading face side of the resilient tucker element and at least one port disposed on the trailing face side of the resilient tucker element.

12. The resilient tucker element of claim 10 further comprising, at least one port disposed on the trailing face side of the resilient tucker element and extending radially outward through at least a portion of the wedge-like protrusion.

13. The resilient tucker element of claim 12, further comprising, at least one port disposed on the leading face side of the resilient tucker element.

14. The resilient tucker element of claim 13, wherein, the port disposed on the leading face side does not extend through the wedge-like protrusion.

15. A resilient tucker element for an interfolding apparatus having a pair of cooperating interfolding rolls rotatably disposed to form a nip therebetween with each roll having at least one circumferentially spaced gripper arrangement therein disposed in timed relationship to the at least one gripper arrangement of the other of the interfolding rolls and the rolls also each defining respective tucker mounting surfaces circumferentially spaced in a timed relationship to the gripper arrangement of the other roll such that the tucker mounting surface of one roll is substantially aligned with the gripper apparatus of the other roll as the gripper arrangements of each roll respectively pass through the nip, the resilient tucker element comprising:
a body formed at least partially of elastically resilient material attachable at a proximal end thereof to the tucker mounting surface of one of the rolls and having a distal end thereof configured for operative engagement with the gripper apparatus on the other roll, for guiding one or more sheets of material passing through the nip substantially simultaneously with the distal end of the tucker on the one roll into the gripper on the other roll.

16. The resilient tucker element of claim 15, wherein, the proximal end of the tucker body is fixedly attached to the roll.

17. The resilient tucker element of claim 16, wherein, the tucker body includes a base at the proximal end thereof for fixed attachment of the resilient tucker element to the mounting surface of the roll.

18. The resilient tucker element of claim 15, wherein, the tucker body is formed at least partially from a polyurethane material.

19. The resilient tucker element of claim 15, wherein:
at least one of the folding rolls is rotatable about a roll axis and defines a substantially circumferential periphery of that roll disposed about the roll axis; and
the tucker body includes a tucker tip at the distal end thereof;
the tip of the tucker extending outward beyond the periphery of the folding roll when the tip is in a neutral position thereof,
the tip being movable from the neutral position thereof simultaneously in at least two of the three directions consisting of substantially radially inward toward the roll axis, substantially circumferentially along the periphery of the folding roll and substantially compound-bending about a secondary bending axis of the tip.

20. The resilient tucker element of claim 19, wherein, the tucker tip extends a first distance beyond the periphery of the folding roll when the tucker tip is in the neutral position, and is movable to a second distance from the periphery of the roll which is less than the first distance from the folding roll.

21. The resilient tucker element of claim 19, wherein, the tip of the tucker is movable to a non-protruding position whereat the tip does not extend beyond the periphery of the folding roll.

22. The resilient tucker element of claim 15, wherein:
the tucker body includes a tucker tip at the distal end thereof, a tucker base at the proximal end thereof, and an intermediate section of the tucker extending between the tip and the base; and
at least the intermediate section of the tucker is formed at least partly from the elastically resilient material.

23. The resilient tucker element of claim 22, wherein, the intermediate section of the tucker body is formed at least partially from a polyurethane material.

24. The resilient tucker element of claim 23, wherein, the tucker tip is at least partially formed from a hard, wear resistant and low friction material.

25. The resilient tucker element of claim 24, wherein, the tucker tip is at least partially formed from a metallic material.

26. The resilient tucker element of claim 24, wherein, the tucker tip is at least partially formed from a material of the group consisting of: metallic materials, steel, ceramic, and high-durometer urethane or other plastic.

27. The resilient tucker element of claim 24, further comprising, one or more passages extending in fluid communication through the base and the intermediate section and the tip, and terminating in ports at the tip of the resilient tucker element.

28. The resilient tucker element of claim 27, wherein, the passages are tapered from a larger cross sectional area adjacent the base to a smaller cross sectional area adjacent the ports.

29. The resilient tucker element of claim 27, wherein, the tip includes a wedge-like protrusion extending therefrom defining a leading face side and a trailing face side of the resilient tucker element disposed on opposite sides of the wedge-like protrusion, with the ports being disposed on at least one side of the wedge-like protrusion.

30. The resilient tucker element of claim 29, further comprising, at least one port disposed on the leading face side of the resilient tucker element and at least one port disposed on the trailing face side of the resilient tucker element.

31. The resilient tucker element of claim 29, further comprising, at least one port disposed on the trailing face side of the resilient tucker element and extending radially outward through at least a portion of the wedge-like protrusion.

32. The resilient tucker element of claim 31, further comprising, at least one port disposed on the leading face side of the resilient tucker element.

33. The resilient tucker element of claim 32, wherein, the port disposed on the leading face side does not extend through the wedge-like protrusion.

34. A resilient tucker element for an interfolding apparatus having a pair of cooperating interfolding rolls rotatably disposed to form a nip therebetween with each roll having at least one circumferentially spaced gripper arrangement therein disposed in timed relationship to the at least one gripper arrangement of the other of the interfolding rolls and the rolls also each defining respective tucker mounting surfaces circumferentially spaced in a timed relationship to the gripper arrangement of the other roll such that the tucker mounting surface of one roll is substantially aligned with the gripper apparatus of the other roll as the gripper arrangements of each roll respectively pass through the nip, the resilient tucker element comprising:
a tucker body attachable at a proximal end thereof to the tucker mounting surface of one of the rolls and having a tucker tip at a distal end thereof configured for operative engagement with the gripper apparatus on the other roll, for guiding one or more sheets of material passing through the nip substantially simultaneously with the distal end of the tucker on the one roll into the gripper on the other roll;
the resilient tucker element further defining one or more passages extending in fluid communication through the tucker body and terminating in at least one port at the tip of the resilient tucker element;
the tip including a wedge-like protrusion extending therefrom and defining a leading face side and a trailing face side of the resilient tucker element disposed on opposite sides of the wedge-like protrusion; and
the tip further defining at least one port disposed on the trailing face side of the resilient tucker element and extending through at least a portion of the wedge-like protrusion.

35. The resilient tucker element of claim 34, wherein, the passages are tapered from a larger cross sectional area adjacent the base to a smaller cross sectional area adjacent the ports.

36. The resilient tucker element of claim 34, further comprising, at least one port disposed on the leading face side of the resilient tucker element and at least one port disposed on the trailing face side of the resilient tucker element.

37. The resilient tucker element of claim 34, wherein, the passages are tapered from a larger cross sectional area adjacent the base to a smaller cross sectional area adjacent the ports.

38. The resilient tucker element of claim 34, wherein, the tucker body is formed at least partially of elastically resilient material attachable at a proximal end thereof to the tucker mounting surface of one of the rolls.

39. The resilient tucker element of claim 34, wherein, the proximal end of the tucker body is fixedly attached to the roll.

40. The resilient tucker element of claim 39, wherein, the tucker body includes a base at the proximal end thereof for fixed attachment of the resilient tucker element to the mounting surface of the roll.

41. A folding apparatus comprising:
a pair of cooperating interfolding rolls rotatably disposed to form a nip therebetween with each roll having at least one circumferentially spaced gripper arrangement therein disposed in timed relationship to the at least one gripper arrangement of the other of the interfolding rolls and the rolls also each defining respective tucker mounting surfaces circumferentially spaced in a timed relationship to the gripper arrangement of the other roll such that the tucker mounting surface of one roll is substantially aligned with the gripper apparatus of the other roll as the gripper arrangements of each roll respectively pass through the nip; and
a resilient tucker element having a tucker body formed at least partially of elastically resilient material attached at a proximal end thereof to the tucker mounting surface of one of the rolls and having a distal end thereof configured for operative engagement with the gripper arrangement on the other roll, for guiding one or more sheets of material passing through the nip substantially simultaneously with the distal end of the tucker on the one roll into the gripper on the other roll.

42. The folding apparatus of claim 41, wherein:
the tucker has a tucker tip at the distal end thereof configured for operative engagement with the gripper arrangement on the other roll, for guiding one or more sheets of material passing through the nip substantially simultaneously with the distal end of the tucker on the one roll into the gripper on the other roll;
the resilient tucker element further defines one or more passages extending in fluid communication through the tucker body and terminating in at least one port at the tip of the resilient tucker element;
the tip includes a wedge-like protrusion extending therefrom and defining a leading face side and a trailing face side of the resilient tucker element disposed on opposite sides of the wedge-like protrusion; and
the tip further defines at least one port disposed on the trailing face side of the resilient tucker element and extending through at least a portion of the wedge-like protrusion.

43. The resilient tucker element of claim 42, further comprising, at least one port disposed on the leading face side of the resilient tucker element and at least one port disposed on the trailing face side of the resilient tucker element.

44. The apparatus of claim 41, wherein:
each of the rolls defines an outer substantially circumferential surface thereof and rotates about its own respective axis of rotation; and
each roll further includes a longitudinally extending channel therein having sidewalls joined by a bottom surface of the channel disposed radially inward toward the axis from the outer surface of the roll, with the bottom surface of the channel forming the mounting surface for the proximal end of the body of the resilient tucker element.

45. The apparatus of claim 44, wherein, the proximal end of the resilient tucker element includes a base fixedly attached to the mounting surface by one or more threaded fasteners.

46. The apparatus of claim 45, wherein:
the resilient tucker element further comprises a tucker tip at a distal end thereof configured for operative engagement with the gripper apparatus on the other roll, for guiding one or more sheets of material passing through the nip substantially simultaneously with the distal end of the tucker on the one roll into the gripper on the other roll;
the apparatus further defines one or more passages extending in fluid communication through the mounting surface, the tucker body and terminating in at least one port at the tip of the resilient tucker element;
the tip includes a wedge-like protrusion extending therefrom and defining a leading face side and a trailing face side of the resilient tucker element disposed on opposite sides of the wedge-like protrusion; and
the tip further defines at least one port disposed on the trailing face side of the resilient tucker element and extending through at least a portion of the wedge-like protrusion.

47. A folding apparatus comprising:
a pair of cooperating interfolding rolls rotatably disposed to form a nip therebetween with each roll having at least one circumferentially spaced gripper arrangement therein disposed in timed relationship to the at least one gripper arrangement of the other of the interfolding rolls and the rolls also each defining respective tucker mounting surfaces circumferentially spaced in a timed relationship to the gripper arrangement of the other roll such that the tucker mounting surface of one roll is substantially aligned with the gripper apparatus of the other roll as the gripper arrangements of each roll respectively pass through the nip; and
a resilient tucker element having a tucker body attachable at a proximal end thereof to the tucker mounting surface of one of the rolls and having a tucker tip at a distal end thereof configured for operative engagement with the gripper apparatus on the other roll, for guiding one or more sheets of material passing through the nip substantially simultaneously with the distal end of the tucker on the one roll into the gripper on the other roll;
the resilient tucker element further defining one or more passages extending in fluid communication through the tucker body and terminating in at least one port at the tip of the resilient tucker element;
the tip including a wedge-like protrusion extending therefrom and defining a leading face side and a trailing face side of the resilient tucker element disposed on opposite sides of the wedge-like protrusion; and
the tip further defining at least one port disposed on the trailing face side of the resilient tucker element and extending through at least a portion of the wedge-like protrusion.

48. A method for folding material fed through a nip between two folding rolls, the method comprising directing a portion of the material into a gripper arrangement on one of the rolls with a distal end of a resilient tucker element on the other roll, wherein, the resilient tucker element has a tucker body formed at least partially of elastically resilient material fixedly attached at a proximal end thereof to said other roll.
